(19) United States
(12) Patent Application Publication
(10) Pub. No.: US 2005/0118522 A1
(43) Pub. Date: Jun. 2, 2005

(54) Electrophotographic endless belt, electrophotographic apparatus having electrophotographic endless belt, and process for producing electrophotographic endless belt

(75) Inventors: Hidekazu Matsuda, Shizuoka (JP); Akihiko Nakazawa, Shizuoka (JP); Atsushi Tanaka, Shizuoka (JP); Takashi Kusaba, Shizuoka (JP); Yuji Sakurai, Shizuoka (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/986,348

(22) Filed: Nov. 12, 2004

(30) Foreign Application Priority Data
Nov. 28, 2003 (JP) 2003-399887
Dec. 19, 2003 (JP) 2003-422931

(51) Int. Cl. B41M 5/40; G03G 13/14

(52) U.S. Cl. 430/126; 428/32.69

(57) ABSTRACT

An electrophotographic endless belt containing a polyamide resin, carbon black and a filler, characterized in that the polyamide resin is at least one resin selected from the group consisting of polyamide 610, polyamide 612, polyamide 11 and polyamide 12, the filler is at least one filler selected from the group consisting of an oxide, a hydroxide, a carbonate and a silicate, and weight (A) of the polyamide resin and total weight (B) of the carbon black and the filler is in a ratio (A:B) of from 90:10 to 50:50. Also disclosed are an electrophotographic apparatus having the electrophotographic endless belt, and a process for producing the electrophotographic endless belt.

### BACKGROUND OF THE INVENTION

1. Field of the Invention

This invention relates to an electrophotographic endless belt such as a transfer material transporting belt, an intermediate transfer belt or a photosensitive belt, used in electrophotographic apparatus, and also relates to an electrophotographic apparatus having the electrophotographic endless belt, and a process for producing the electrophotographic endless belt.

2. Related Background Art

Besides rigid-body drum-shaped members, flexible endless-belt-shaped members (electrophotographic endless belts) are conventionally used in transfer material transporting members, intermediate transfer members, electrophotographic photosensitive members, fixing members and so forth used in electrophotographic apparatus such as copying machines and laser beam printers.

In recent years, color (such as full-color) electrophotographic apparatus have been put forward into practical use, and there is an increasing demand for transfer material transporting belts, intermediate transfer belt and so forth as well.

An endless belts composed chiefly of a thermoplastic resin is commonly available as the electrophotographic endless belt. The endless belt composed chiefly of a thermoplastic resin has advantages that it can be produced at a low cost and general-purpose extruding machines can be used.

For example, Japanese Patent Application Laid-open No. H03-089357 discloses an electrophotographic endless belt making use of polycarbonate, which is a thermoplastic resin. However, the polycarbonate resin disclosed in Japanese Patent Application Laid-open No. H03-089357 is a non-crystalline resin, and hence the electrophotographic endless belt making use of it has had a poor flexing resistance.

For example, Japanese Patent Application Laid-open No. H08-099374 discloses an electrophotographic endless belt making use of polyalkylene terephthalate, which is a crystalline resin, in order to improve flexing resistance. The use of such a crystalline resin may attain superior flexing resistance. However, where carbon black is used therein as a conducting agent, the resin may come brittle to afford an electrophotographic endless belt consequently having a poor flexing resistance although the resin itself used is one having good flexing resistance.

Thus, in using carbon black as a conducting agent, it is necessary for the resin to have flexing resistance and also be more flexible.

Japanese Patent Application Laid-open No. H05-016263 discloses an electrophotographic endless belt making use of a polyamide resin as a resin which is a crystalline resin and has flexibility. However, polyamide 6 or polyamide 66, which is a commonly available polyamide resin, has amide groups in a high concentration, and hence the use of polyamide 6 or polyamide 66 may bring about a high water absorption to cause dimensional changes concurrently therewith or make large the difference in electrical properties that is due to service environment. Thus, it has been difficult to use such a resin.

Accordingly, it may be contemplated to use, among polyamide resins, a polyamide having an especially low water absorption. However, the polyamide having a low water absorption may inevitably also have a low modulus of elasticity at the same time. When it is used alone, the resultant electrophotographic endless belt may creep (elongate), and has not been durable to long-term service.

Japanese Patent Application Laid-open No. 2001-350347 discloses an electrophotographic endless belt making use of polyamide resin 12, having a low water absorption, and carbon black. In fact, the incorporation of carbon black as a conducting agent brings an improvement in the modulus of elasticity in virtue of reinforcing effect the carbon black has, and may make the belt less creep. However, its effect is not sufficient depending on the types of carbon black, and the belt has not been durable to long-term service.

Thus, the mere use of polyamide resin and carbon black has been unable to afford an electrophotographic endless belt that can be satisfactory in respect of creep resistance.

Japanese Patent Application Laid-open No. 2003-177612 discloses an electrophotographic endless belt making use of polyamide resin and carbon black to which an inorganic filler has been added. In the electrophotographic endless belt disclosed in Japanese Patent Application Laid-open No. 2003-177612, barium sulfate is used as the inorganic filler.

However, in the case when barium sulfate is used as the inorganic filler, it may have an effect on dispersibility as disclosed in that Japanese Patent Application Laid-open No. 2003-177612, but is insufficient for reinforcing effect, consequently having caused creep. In order to improve reinforcing effect, the barium sulfate must be added in a large quantity. However, the addition of barium sulfate in a large quantity, though it may make the creep not easily occur, may bring about a high brittleness, so that breaking or chipping occurs when flexed repeatedly as the electrophotographic endless belt.

Now, usually, it is common for the electrophotographic endless belt to be a belt whose electrical resistance has been controlled by dispersing a conducting agent in a binder resin. For example, a method is available in which an organic antistatic agent or an electrolyte is dispersed in a binder resin. In this method, commonly used is a surface-active agent or a hydrophilic resin as the organic antistatic agent, and a metal salt such as a lithium salt or a potassium salt as the electrolyte.

However, in the case when the surface-active agent or metal salt is used, surface resistivity may be seen to lower, but volume resistivity may lower with difficulty. If it is attempted to control the volume resistivity, the surface-active agent or metal salt must be added in a large quantity to bring about a problem that it may breed out to the surface of the electrophotographic endless belt.

In the case when the hydrophilic resin is used, the electrical resistance can not be lowered unless it is added to the binder resin in a fairly large quantity. Hence, the belt may have a large environmental dependence of electrical resistance value, and has been undesirable.

In addition, where a metal salt having deliquescent properties such as the lithium salt is dispersed in the binder resin in a large quantity, there has been a difficulty that the electrical resistance is greatly affected by moisture.

### SUMMARY OF THE INVENTION

An object of the present invention is to solve the above problems to provide an electrophotographic endless belt that may cause neither cracking nor breaking even in its repeated use, has superior flexing resistance and also may cause no creep even in its long-term service, and provide an electrophotographic apparatus having such an electrophotographic endless belt.

That is, the present invention is an electrophotographic endless belt containing a polyamide resin, carbon black and a filler, characterized in that:
the polyamide resin is at least one resin selected from the group consisting of polyamide 610, polyamide 612, polyamide 11 and polyamide 12;
the filler is at least one filler selected from the group consisting of an oxide, a hydroxide, a carbonate and a silicate; and
weight (A) of the polyamide resin and total weight (B) of the carbon black and the filler is in a ratio (A:B) of from 90:10 to 50:50.

The present invention is also an electrophotographic apparatus characterized by having at least the above electrophotographic endless belt.

The present invention is also a process for producing the above electrophotographic endless belt; the process being characterized by having:
a resin introduction step of introducing the above polyamide resin into a twin-screw extruder; and
a carbon black and filler introduction step of introducing the above carbon black and the above filler into the twin-screw extruder at the time the polyamide resin having been introduced into the twin-screw extruder through the resin introduction step has melted.

### BRIEF DESCRIPTION OF THE DRAWINGS

FIG. 1 is a schematic view showing an example of the construction of an apparatus for producing the electrophotographic endless belt, which employs a blown-film extrusion (inflation molding) method.

FIG. 2 is a schematic view showing another example of the construction of an apparatus for producing the electrophotographic endless belt, which employs a blown-film extrusion (inflation molding) method.

FIG. 3 is a schematic view showing an example of the construction of an extruder.

FIG. 4 is a schematic view showing an example of the construction of an intermediate transfer type color electrophotographic apparatus.

FIG. 5 is a schematic view showing an example of the construction of an in-line type color electrophotographic apparatus.

FIG. 6 is a schematic view showing another example of the construction of the intermediate transfer type color electrophotographic apparatus.

FIG. 7 is a schematic view showing the construction of a flexing tester.

### DETAILED DESCRIPTION OF THE PREFERRED EMBODIMENTS

The electrophotographic endless belt of the present invention contains a polyamide resin, carbon black and a filler.

The polyamide resin refers to a high polymer having as a repeating unit an amide linkage (—CONH—) in the molecule, and is also called a nylon resin.

The polyamide resin has good flexibility and chemical resistance and also good wear resistance and rub resistance, and hence it is preferable as a material for the electrophotographic endless belt. Also, because of its flexibility, when the polyamide is used in an intermediate transfer belt or a transfer material transporting belt, soft transfer is possible, and good images can be obtained which have been made to have less hollow characters or spots around line images.

As a result of extensive studies on-polyamide resins, the present inventors have found that polyamide 610, polyamide 612, polyamide 11 or polyamide 12, having a very lower water absorption than polyamide 6 or polyamide 66, is preferable as a material for achieving the object of the present invention.

The above four types of polyamide resins have an especially low water absorption among many polyamide resins, have good dimensional stability, and may less cause variations of electrical resistance value against environmental changes. They also have lower melting points than other polyamide resins, can be extruded or molded at a relatively low temperature, have a large difference between melt temperature and decomposition temperature, have a broad temperature range in which they can be extruded or molded, and have good extrusion or molding stability. Also, they may require only a small amount of energy to be consumed for heating.

Usually, the polyamide resins tend to increase in the modulus of elasticity with an increase in the concentration of amide linkages (—CONH—), but tend to increase in water absorption as well. The polyamide 610, polyamide 612, polyamide 11 and polyamide 12 have low melting points, are flexible and also have a low water absorption insofar as they have long methylene chains, but on the other hand they tend to have a low modulus of elasticity.

The polyamide 610 is also called polyhexamethylene sebacamide (nylon 610). Also, the polyamide 12 is also called polydodecanamide (nylon 12).

The polyamide 610 is obtained by polycondensation of hexamethylene diamine (HMD) and sebasic acid, and the polyamide 612 is obtained by polycondensation of hexamethylene diamine (HMD) and dodecanedioic acid. Also, the polyamide 11 is obtained by polycondensation of 11-aminoundecanoic acid, and the polyamide 12 is obtained by ring-opening polymerization of ω-laurolactam or polycondensation of 12-aminododecanoic acid.

In the present invention, the polyamide resin may preferably be one having a molecular weight in the range of from 5,000 to 50,000 as number-average molecular weight.

The polyamide 610, polyamide 612, polyamide 11 and polyamide 12 are commonly commercially available with ease. For example, they may include AMILAN, available from Toray Industries, Inc.; RILSAN, available from Atofina Co.; GRILLAMIDE, available from Ems Showa Denko K.K.; DIAMID, available from Daicel-Degussa Ltd; UBE Nylon, available from Ube Industries, Ltd.; and ZYTEL, available from Du Pont.

In the present invention, the polyamide resin may also include copolymers of polyamide 610, copolymers of polyamide 612, copolymers of polyamide 11 and copolymers of polyamide 12, as well as polymer alloys and polymer blends of any of these.

The polyamide resin in the present invention may be used alone or may be used in combination of two or more types, among the above four types. When used in combination of two or more types, they may be used under appropriate selection of mixing proportion in accordance with the required modulus of elasticity and water absorption. The modulus of elasticity and water absorption depend on the concentration of amide linkages (—CONH—) as described above.

In the present invention, a plurality of polyamide resins selected from polyamide 610, polyamide 612, polyamide 11 and polyamide 12 may also be used. The polyamide 610 and polyamide 612 have a higher water absorption but have a higher modulus of elasticity than the polyamide 11 and polyamide 12. Accordingly, when a higher modulus of elasticity is required, the content of polyamide 610 or polyamide 612 may be made higher, and, when a lower water absorption is required, the content of polyamide 11 or polyamide 12 may be made higher.

Making the content of polyamide 610 or polyamide 612 higher is also advantageous when transfer residual toner on the surface of the electrophotographic endless belt is removed by cleaning (such as electrostatic cleaning or blade cleaning).

Thus, in the case when two or more types of polyamide resins are used, the content of each polyamide resin may appropriately be controlled in accordance with the rating of properties required for the electrophotographic endless belt. In particular, when two types of polyamide resins are used, their preferable mixing ratio is 10:90 to 90:10.

In the present invention, in order to control the electrical resistance value of the electrophotographic endless belt, carbon black is used as a conducting agent. The carbon black can not easily be affected by temperature and humidity on electrical resistance as organic antistatic agents or electrolytes can be. Also, it has no possibility of bleeding out to the electrophotographic endless belt surface. Still also, it has a reinforcing effect on the binder resin, and also can improve creep resistance of the electrophotographic endless belt.

The carbon black used in the present invention may include furnace black, thermal black, gas black, acetylene black and KETJEN BLACK. Carbon black for coloring may also sufficiently function as the conducting agent.

The above carbon black is commercially available with ease. For example, it may include, as acetylene black, DENKA BLACK (powdery products, granular products, pressed products, HS-100, etc.), available from Denki Kagaku Kogyo Kabushiki Kaisha; KETJEN BLACK (EC, EC600JD), available from Lion Corporation; COLOR BLACK, SPECIAL BLACK, PRINTEX, HI BLACK and LAMP BLACK, available from Deggusa Corp.; RAVEN, available from Columbian Carbon; VULCAN, MONARCH, REGAL, BLACK PEARLS and MOGUL, available from Cabot Corp.; ASAHI CARBON, available from Asahi Carbon Co., Ltd.; and TOKA BLACK, available from Tokai Carbon Co., Ltd.

If the content of the carbon black is too large, the extrusion material may be formed into an endless belt with difficulty. Depending on the types of the carbon black, some materials can be extruded even when the carbon black is contained in a large quantity. However, where the content of the carbon black is too high, the electrophotographic endless belt obtained can have a high modulus of elasticity and can be improved in creep resistance, but the electrophotographic endless belt may have a high brittleness to have a poor flexing resistance instead. The carbon black may preferably be in a content of less than 40% by weight based on the total weight of the electrophotographic endless belt.

If on the other hand the content of the carbon black is too small, the desired electrical resistance of the electrophotographic endless belt may not be attained, or any sufficient reinforcing effect may not be attained, resulting in a low modulus of elasticity or tending to cause creep. The carbon black may preferably be in a content of 2% by weight or more based on the total weight of the electrophotographic endless belt.

Incidentally, a conducting agent(s) other than the carbon black may further be added to the electrophotographic endless belt of the present invention.

As a method for adding the carbon black, a master batch method may be used in order to improve dispersibility.

A filler other than the carbon black is further added to the electrophotographic endless belt of the present invention. The filler other than the carbon black refers to an oxide, a hydroxide, a carbonate or a silicate.

The oxide may include, e.g., silica, diatomaceous earth, alumina, zinc oxide, titanium oxide, calcium oxide, magnesium oxide, iron oxide, tin oxide, antimony oxide, and ferrite.

The hydroxide may include, e.g., calcium hydroxide, magnesium hydroxide and aluminum hydroxide. The hydroxide has not only reinforcing effect but also flame-retardant effect.

The carbonate may include, e.g., calcium carbonate, magnesium carbonate, zinc carbonate, barium carbonate, dawsonite and hydrotalcite.

The silicate may include, e.g., clay, activated clay, sepiolite, imogolite and sericite.

The use of the carbon black and the above filler in combination enables formation of good reproduced images, compared with a case in which the electrical resistance is controlled using only the carbon black.

The addition of the above filler to the polyamide resin enhances the modulus of elasticity of the electrophotographic endless belt, and consequently brings the effect of preventing creep and enduring long-term service.

The addition of the above filler, having a low water absorption, is also effective in lowering the water absorption of the electrophotographic endless belt making use of the polyamide resin. As the result, the electrophotographic endless belt can have small environmental variations, and good images can be obtained in either of a low-temperature and low-humidity environment and a high-temperature and high-humidity environment.

Incidentally, the above filler used in the present invention differs from the inorganic filler disclosed in Japanese Patent Application Laid-open No. 2003-177612. The barium sulfate as the inorganic filler disclosed in Japanese Patent Application Laid-open No. 2003-177612 is a filler that acts as a dispersing agent of carbon black, whereas the above filler used in the present invention is a filler that acts on the reinforcement of the electrophotographic endless belt. The barium sulfate, which is a sulfate, has a low reinforcing effect.

The dispersibility of carbon black can be improved by selecting the type of carbon black or a kneading method therefor, or by adding a dispersing agent, and this enables satisfaction of the function required as the electrophotographic endless belt.

The above filler used in the present invention may preferably have a particle diameter of from 0.01 μm to 5 μm. If it has a particle diameter of less than 0.01 μm, the filler may scatter to make operability poor, making it difficult to effect uniform dispersion. If it has a particle diameter of more than 5 μm, the effect of reinforcing the electrophotographic endless belt may be obtained with difficulty, and also such a filler may appear as pimples on the electrophotographic endless belt surface.

The particle shape of the filler may include a granular shape (spherical, or amorphous), a platelike shape and a fibrous shape (acicular). The above particle diameter is an average value taken between the maximum diameter and the minimum diameter.

The above filler used in the present invention need not necessarily have conductivity, and may suffice as long as it contributes to an improvement in the mechanical strength of the electrophotographic endless belt. Of course, one having conductivity may also be used.

In the electrophotographic endless belt of the present invention, the proportion (ratio) of the content of the above polyamide resin to the content of the carbon black plus the above filler is as follows (weight ratio):
[the above polyamide resin]:[the carbon black plus the above filler]=90:10 to 50:50.

It may preferably be as follows:
[the above polyamide resin]:[the carbon black plus the above filler]=75:25 to 60:40.

Even those which are relatively inactive to the above polyamide resin, like the carbon black and the above filler, there is a limit to the quantity in which the above polyamide resin can cover the particles surfaces of the carbon black or those of the above filler. Hence, if the carbon black and the above filler are in a too large total weight, the material can not be extruded into an endless belt. If on the other hand the carbon black and the above filler are in a too small total weight, the effect of reinforcing the electrophotographic endless belt may not sufficiently be obtained, and the electrophotographic endless belt may creep.

In general, polyamide resins may undergo great changes in melt viscosity in respect to temperature, and, where extrusion or the like is carried out, they have a narrow temperature range in which the material can stably be extruded. In order to carry out the extrusion stably, it is preferable for the electrophotographic endless belt of the present invention to contain a modified polyolefin.

This modified polyolefin is meant to be a polyolefin (polyethylene, polypropylene) into the molecular chain of which a functional group having reactivity (e.g., an epoxy group, a maleic anhydride group or an oxazoline group) has been introduced.

Such a modified polyolefin may include, e.g., epoxy-group-containing olefin copolymers, an ethylene/glycidyl methacrylate copolymer, a maleic anhydride/ethylene copolymer, an ethylene/vinyl acetate/glycidyl methacrylate terpolymer, an ethylene/ethyl acrylate/glycidyl methacrylate terpolymer, an ethylene/glycidyl acrylate copolymer, an ethylene/vinyl acetate/glycidyl acrylate terpolymer and an ethylene/acrylate/maleic anhydride terpolymer.

Such a modified polyolefin is commonly commercially available with ease. It may include, e.g., BOND FAST, available from Sumitomo Chemical Co., Ltd.; BONDYNE, available from Sumitomo Atofina Co., Ltd.; REXPEARL, and ADOTEX, available from Nippon Polyethylene Co., Ltd.; MODIPER, available from Nippon Oil & Fats Co., Ltd.; and Umex, available from Sanyo Chemical Industries, Ltd.

The modified polyolefin, particularly modified polyethylene also has superior non-adhesive properties compared with the polyamide resin, and has the effects of making toner less adhere to the surface of the electrophotographic endless belt or making toner having scattered inside the electrophotographic apparatus less adhere to the back of the electrophotographic endless belt, and improving cleaning performance for toner having adhered to the surface of the electrophotographic endless belt.

In general, the modified polyolefin has a lower modulus of elasticity than the polyamide resin, where the modulus of elasticity of the electrophotographic endless belt tends to decrease with an increase in the amount of the modified polyolefin added to the electrophotographic endless belt, and this may promote the creep of the electrophotographic endless belt. Accordingly, it may preferably be in an amount of less than 50% by weight based on the weight of the polyamide resin.

For the purpose of improving various properties, the electrophotographic endless belt of the present invention may also be incorporated with a thermoplastic elastomer. The thermoplastic elastomer may be one having conductivity.

The thermoplastic elastomer may include, e.g., thermoplastic elastomers of a polyolefin type, a polystyrene type, a polyamide type, a polyester type, a hydrogenated SBS type and a polyurethane type.

However, in the case of the thermoplastic elastomer as well, the modulus of elasticity of the electrophotographic endless belt tends to decrease with an increase in the amount of the thermoplastic elastomer added to the electrophotographic endless belt, and this may promote the creep of the electrophotographic endless belt. Accordingly, it may preferably be in an amount of less than 50% by weight based on the weight of the polyamide resin.

In regard to the heat at the time of extrusion in producing the electrophotographic endless belt, a large shear force is applied when the carbon black and the above filler are kneaded using a twin-screw extruder, and this may cause self-generation of heat to make part of the polyamide resin undergo thermal decomposition. Accordingly, the electrophotographic endless belt of the present invention may preferably contain an antioxidant.

The antioxidant may include copper halides (e.g., copper (I) iodide), potassium halides (e.g., potassium iodide), hindered phenyl types, phosphorus types and phosphite types. Any of these may be used alone or may be used in the form of a mixture of two or more types.

The phosphite type antioxidant may include ADEKASTAB PEP-36, available from Asahi Denka Kogyo K.K., and IRGAPHOS, available from Ciba Specialty Chemicals Inc.

The hindered phenyl type antioxidant may include IRGANOX 1010 (pentaerythritol tetrakis[3-(3,5-di-tert-butyl-4-hydroxyphenyl) Propionate], IRGANOX 1098, and IRGANOX 245, available from Ciba Specialty Chemicals Inc.

A flame retardant may be added to the electrophotographic endless belt of the present invention.

As the flame retardant, melamine and melamine cyanurate, which are triazine compounds, and phosphorus type flame retardants are preferred because they bring out an especially remarkable effect on the polyamide resin.

For the purpose of improving dispersibility of the carbon black and the above filler, the electrophotographic endless belt may also be incorporated with a dispersing agent.

The dispersing agent may include polyglycerol poly-ricinolate and polyglycerol stearate.

The dispersing agent may be used to carry out dispersion treatment by a known treating method (such as a wet process or a dry process) by means of a known treating apparatus (such as Henschel mixer or Super mixer).

In addition to the components described above, other component(s) may also be added to the electrophotographic endless belt as long as the effect of the present invention is not damaged. Such other component(s) may include, e.g., a processing aid, a lubricant, a release agent, a plasticizer, a colorant, a nucleating agent and an age resistor.

The process for producing the electrophotographic endless belt may include, e.g., extrusion, blown-film extrusion (inflation), injection molding, and blow molding. In particular, blown-film extrusion is preferred.

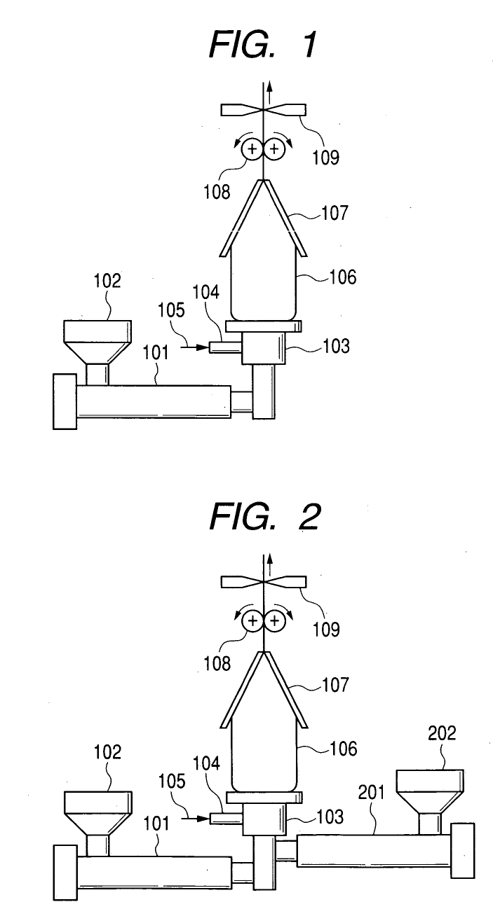

FIG. 1 is a schematic view showing an example of the construction of an apparatus for producing the electrophotographic endless belt, which employs the blown-film extrusion.

First, an extrusion material prepared by premixing the above polyamide resin, carbon black and filler under the stated formulation, followed by kneading and dispersion, is put into an extruder 101 from a hopper 102. Temperature and screw construction in the extruder 101 are so selected that the extrusion material may have a melt viscosity for enabling extrusion into a belt and also the conductive filler is uniformly dispersed in the extrusion material.

The extrusion material is melt-kneaded in the extruder 101 into a melt, which then enters a circular die 103. The circular die 103 is provided with a gas inlet passage 104. Through the gas inlet passage 104, gas 105 such as air is blown into the circular die 103, whereupon the melt having passed through the circular die 103 inflates while scaling up in the diametrical direction. Incidentally, the extrusion may be carried out without blowing the gas 105 into the gas inlet passage 104.

The extruded product (tubular film 106) having thus inflated is drawn upward by a pinch roller 108 while being cooled by a cooling ring (not shown). When the tubular film 106 is drawn upward, it passes through the space defined by a dimension stabilizing guide 107, whereby the length in peripheral direction (peripheral length) of the electrophotographic endless belt is fixed, and also it is cut with a cutter 109, whereby the length in generatrix direction (width) of the electrophotographic endless belt is fixed.

Thus, the electrophotographic endless belt can be obtained.

The foregoing description relates to production of an electrophotographic endless belt of single-layer construction. In the case of an electrophotographic endless belt of double-layer construction, a second extruder 201 is additionally provided as shown in FIG. 2 (202 denotes a second hopper). A melt from the extruder 101 and a melt from the extruder 201 are simultaneously sent into a circular die 103, and the two layers are scale-up inflated simultaneously, thus the electrophotographic endless belt of double-layer construction can be obtained. In the case of triple- or more layer construction, the extruder may be provided in the number corresponding to the number of layers.

As a method of removing folds of the endless belt which have been made in the process of blown-film extrusion or making the endless belt surface smooth, a method is available which makes use of a set of cylindrical forms made of materials having different coefficients of thermal expansion and having different diameters.

Stated specifically, a small-diameter cylindrical form (inner form) has a coefficient of thermal expansion made larger than the coefficient of thermal expansion of a large-diameter cylindrical form (outer form). The tubular film (endless belt) obtained by extrusion is placed over this inner form. Thereafter, the inner form with film is inserted into the outer form so that the tubular film (endless belt) is held between the inner form and the outer form. A gap between the inner form and the outer form may be determined by calculation on the bases of heating temperature, difference in coefficient of thermal expansion between the inner form and the outer form and pressure required.

A form in which the inner form, the endless belt and the outer form have been set in the order from the inside is heated to the vicinity of the softening point temperature of the polyamide resin used in the endless belt. As a result of the heating, the inner form, having a larger coefficient of thermal expansion, acts so as to expand more than the inner diameter of the outer form and hence a uniform pressure is applied to the whole endless belt. Here, the surface of the endless belt having reached the vicinity of its softening point is pressed against the inner surface of the outer form, so that the folds can be removed. Thereafter, these are cooled, and then the endless belt is removed from the forms, thus an endless belt from which the folds have been removed can be obtained. This method enables dimensional control and modification of surface properties simultaneously. Also, the endless belt to be placed over the inner form may be superposed in plurality, whereby a multi-layer endless belt is obtainable.

Incidentally, the electrophotographic endless belt of the present invention may have a joint, or may have no joint. That is, the material may be extruded in the shape of a sheet, and thereafter the sheet may be rolled up, and then joined by ultrasonic welding or the like. Also, the inner form and outer form as described above may be used to obtain the endless belt.

The electrophotographic endless belt of the present invention may preferably have a thickness of from 50 μm to 250 μm. If the electrophotographic endless belt is too thick, it may have a low belt travel performance because of a high rigidity and a poor flexibility to cause deflection or one-sided travel. If on the other hand the electrophotographic endless belt is too thin, it may have a low tensile strength or may cause creep as a result of long-term service.

Incidentally, before the above blown-film extrusion is carried out, the extrusion material is obtained by premixing the above polyamide resin, carbon black and filler under the stated formulation, followed by kneading and dispersion. As a method therefor, a method is preferred in which these are kneaded by means of a twin-screw extruder to obtain the extrusion material.

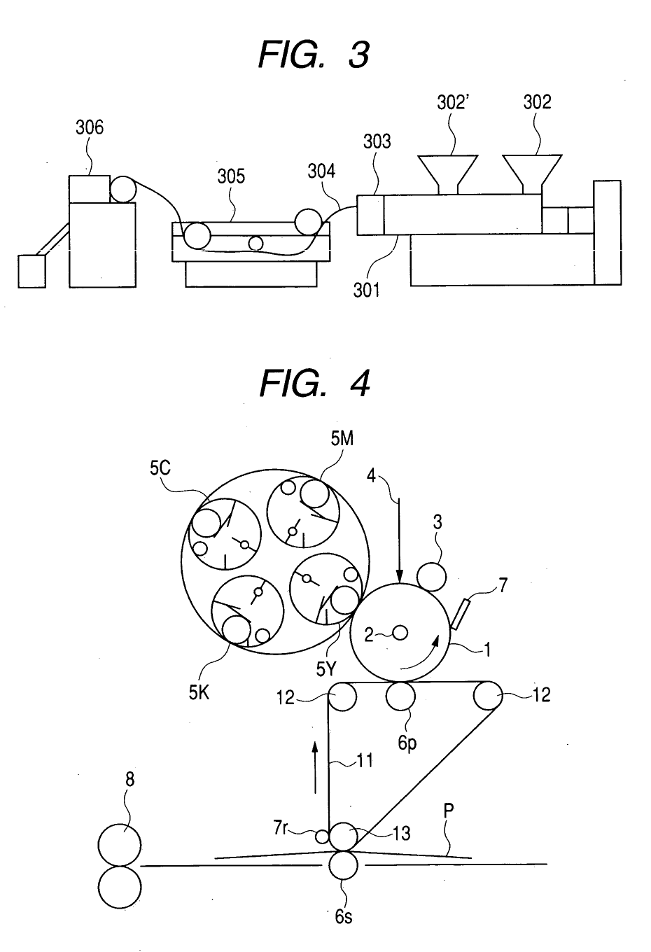

FIG. 3 schematically illustrates an example of the construction of the twin-screw extruder.

It is common that components constituting the extrusion material are introduced at one time from a hopper 302 into a twin-screw extruder 301. However, the electrophotographic endless belt is required to have a higher precision than commonly available resin extruded products and also the carbon black and the filler must be more improved in their dispersibility. Hence, a method is preferred in which the polyamide resin is first introduced into the twin-screw extruder 301, and then, at the stage where the polyamide resin has melted, the carbon black and the filler are introduced into the twin-screw extruder 301 (side feed, i.e., halfway introduction). In FIG. 3, reference numeral 302′ also denotes a hopper.

Materials melt-kneaded by the twin-screw extruder are extruded from a strand die 303 in the form of a strand 304, which is then passed through a water bath 305 so as to be cooled, and then passed through a strand cutter 306 to obtain the extrusion material.

The kneading in the twin-screw extruder may be one-time kneading, or what has first been passed through the twin-screw extruder may be kneaded two or more times by means of the twin-screw extruder (two or more time kneading).

The twin-screw extruder may include, e.g., TEX, manufactured by The Japan Steel Works, Ltd. (JSW); TEM, manufactured by Toshiba Machine Co., Ltd.; and PCM, manufactured by Ikegai Corp.

In the blown-film extrusion (inflation molding) described above, the extrusion material is beforehand obtained and then extruded in the shape of an endless belt. However, the extrusion material may be extruded in the shape of an endless belt through one step.

The electrophotographic endless belt of the present invention may preferably have a volume resistivity of from 1×10⁶ to 1×10¹⁴ Ω·cm. If the electrophotographic endless belt has too low volume resistivity, it may attract and hold transfer material with difficulty when, e.g., used as a transfer material transporting belt. If on the other hand the electrophotographic endless belt has too high volume resistivity, electric charges may tend to accumulate in the electrophotographic endless belt to make it difficult to perform charge elimination. Also, it is necessary to make transfer voltage higher, and this may require a large-size power source or cause a rise in cost.

A method of measuring the volume resistivity of the electrophotographic endless belt in the present invention is described below.

Measuring Machine
Resistance meter: Ultra-high resistance meter R8340A (manufactured by Advantest Corporation).
Sample box: Sample box TR42 for ultra-high resistance meter (manufactured by Advantest Corporation).

The main electrode is 25 mm in diameter, and the guard-ring electrode is 41 mm in inner diameter and 49 mm in outer diameter.

Sample

The electrophotographic endless belt is cut in a circular form of 56 mm in diameter. After cutting, it is provided, on its one side, with an electrode over the whole surface by forming a Pt-Pd deposited film and, on the other side, provided with a main electrode of 25 mm in diameter and a guard electrode of 38 mm in inner diameter and 50 mm in outer diameter by forming Pt-Pd deposited films. The Pt-Pd deposited films are formed by carrying out vacuum deposition for 2 minutes using Mild Sputter E1030 (manufactured by Hitachi Ltd.). The one on which the vacuum deposition has been carried out is used as the sample.

Measurement Conditions
Measurement atmosphere: 23° C./55% RH(N/N) Here, the measuring sample is previously kept left in an environment of 23° C./55% RH for 12 hours or more.).
Measurement mode: Discharge for 10 seconds, and charge and measurement for 30 seconds.
Applied voltage: 100 V.

As the applied voltage, employed is 100 V in 1 to 1,000 V which is the range of the voltage applied to the electrophotographic endless belt in the electrophotographic apparatus.

The electrophotographic endless belt of the present invention may be constituted of a single layer, or may be constituted of a multiple layer consisting of a plurality of layers.

The electrophotographic endless belt is used in the electrophotographic apparatus usually in the state it is stretched over a plurality of stretch-over rollers. Here, if it is difficult to prevent the electrophotographic endless belt from meandering, because of straightness, shake or the like of the stretch-over rollers, the electrophotographic endless belt may be provided with a meandering preventive member (a rib or the like).

The polyamide resin used in the present invention may be evaluated or observed by conventionally known methods. For example, to distinguish the types of polyamide resins, measurement of melting points by DSC (differential scanning calorimetry) may be employed. As a measuring instrument for the DSC, any known instrument may be used. For example, where polyamide 610 and polyamide 12 are used in the form of a mixture, peaks that accompany melting are observed at two spots in the vicinity of 215° C. which is the melting point of the polyamide 610 and in the vicinity of 176° C. which is the melting point of the polyamide 12. Also, their mixing ratio can be judged from differences in intensity of the respective peaks (differences in peak area and latent heat of fusion).

FIG. 4 schematically illustrates an example of the construction of a color electrophotographic apparatus of an intermediate transfer system. The transfer of toner images from an electrophotographic photosensitive member to a transfer material is chiefly performed by a primary transfer charging member, an intermediate transfer belt and a secondary transfer charging member.

In FIG. 4, reference numeral 1 denotes a cylindrical electrophotographic photosensitive member, which is rotatingly driven around an axis 2 in the direction of an arrow at a prescribed peripheral speed.

The electrophotographic photosensitive member 1 is uniformly electrostatically charged on its surface to a positive or negative, stated potential through a primary charging member 3. The photosensitive member thus charged is then exposed to exposure light (imagewise exposure light) 4 emitted from an exposure means (not shown) for slit exposure or laser beam scanning exposure. The exposure light used here is exposure light corresponding to a first-color-component image (e.g., a yellow-component image) of an intended color image. Thus, on the surface of the electrophotographic photosensitive member 1, first-color-component electrostatic latent images (yellow-color-component electrostatic latent image) are successively formed which correspond to the first-color-component image of the intended color image.

An intermediate transfer belt 11 stretched over stretch-over rollers 12 and a secondary-transfer opposing roller 13 is rotatingly driven in the direction of an arrow at substantially the same peripheral speed as the electrophotographic photosensitive member 1 (e.g., at a speed of 97 to 103% in respect to the peripheral speed of the electrophotographic photosensitive member 1).

The first-color-component electrostatic latent images formed on the surface of the electrophotographic photosensitive member 1 are developed with a first-color toner (yellow toner) contained in a developer held by a first-color developer carrying member (yellow developer carrying member) 5Y, to form a first-color toner image (yellow toner image). Then, the first-color toner images formed and held on the surface of the electrophotographic photosensitive member 1 are successively primarily transferred on to the surface of the intermediate transfer belt 11 passing through between the electrophotographic photosensitive member 1 and a primary-transfer charging member (primary-transfer charging roller) 6p, by the aid of a primary-transfer bias applied from the primary-transfer charging member 6p.

The surface of the electrophotographic photosensitive member 1 from which the first-color toner images have been transferred is cleaned by a cleaning member 7 to remove primary-transfer residual developer (toner) to make the surface clean. Thereafter, the photosensitive member thus cleaned is used for the next-color image formation.

Second-color toner images (magenta toner images), third-color toner images (cyan toner images) and fourth-color toner images (black toner images) are transferred to the surface of the electrophotographic photosensitive member 1 and then sequentially primarily transferred to the surface of the intermediate transfer belt 11, in the same manner as the first-color toner images. Thus, synthesized toner images corresponding to the intended color image are formed on the surface of the intermediate transfer belt 11. In the course of the first-color to fourth-color primary transfer, a secondary-transfer charging member (secondary-transfer charging roller) 6s and a charge-providing member (charge-providing roller) 7r stand separate from the surface of the intermediate transfer belt 11.

The synthesized toner images formed on the surface of the intermediate transfer belt 11 are successively secondarily transferred on to a transfer material (such as paper) P by the aid of a secondary-transfer bias applied from the secondary-transfer charging member 6s; the transfer material P being taken out and fed from a transfer material feeding means (not shown) to the part (contact zone) between the secondary-transfer opposing roller 13/intermediate transfer belt 11 and the secondary-transfer member 6s in the manner synchronized with the rotation of the intermediate transfer belt 11.

The transfer material P to which the synthesized toner images have been transferred is separated from the surface of the intermediate transfer belt 11 and guided into a fixing means 8, where the synthesized toner images are fixed, and is then put out of the apparatus as a color image-formed matter (a print or a copy).

The charge-providing member 7r is brought into contact with the surface of the intermediate transfer belt 11 from which the synthesized toner images have been transferred. The charge-providing member 7r provides the secondary-transfer residual developers (toners) held on the surface of the intermediate transfer belt 11, with electric charges having a polarity reverse to that at the time of primary transfer. The secondary-transfer residual developers (toners) having been provided with electric charges having the polarity reverse to that at the time of primary transfer are electrostatically transferred to the surface of the electrophotographic photosensitive member 1 at the contact zone between the electrophotographic photosensitive member 1 and the intermediate transfer belt 11 and the vicinity thereof. Thus, the surface of the intermediate transfer belt 11 from which the synthesized toner images have been transferred is cleaned by the removal of the transfer residual developers (toners). The secondary-transfer residual developers (toners) having been transferred to the surface of the electrophotographic photosensitive member 1 are removed by the cleaning member 7 together with the primary-transfer residual developers (toners) held on the surface of the electrophotographic photosensitive member 1. The transfer of the secondary-transfer residual developers (toners) from the intermediate transfer belt 11 to the electrophotographic photosensitive member 1 can be performed simultaneously with the primary transfer, and hence the though-put does not lower.

The surface of the electrophotographic photosensitive member 1 from which the transfer residual developers (toners) have been removed by the cleaning member 7 may also be subjected to charge elimination by pre-exposure light emitted from a pre-exposure means. However, where as shown in FIG. 4 contact charging making use of a roller-shaped primary charging member (a primary charging roller) or the like is employed in the charging of the surface of the electrophotographic photosensitive member, the pre-exposure is not necessarily required.

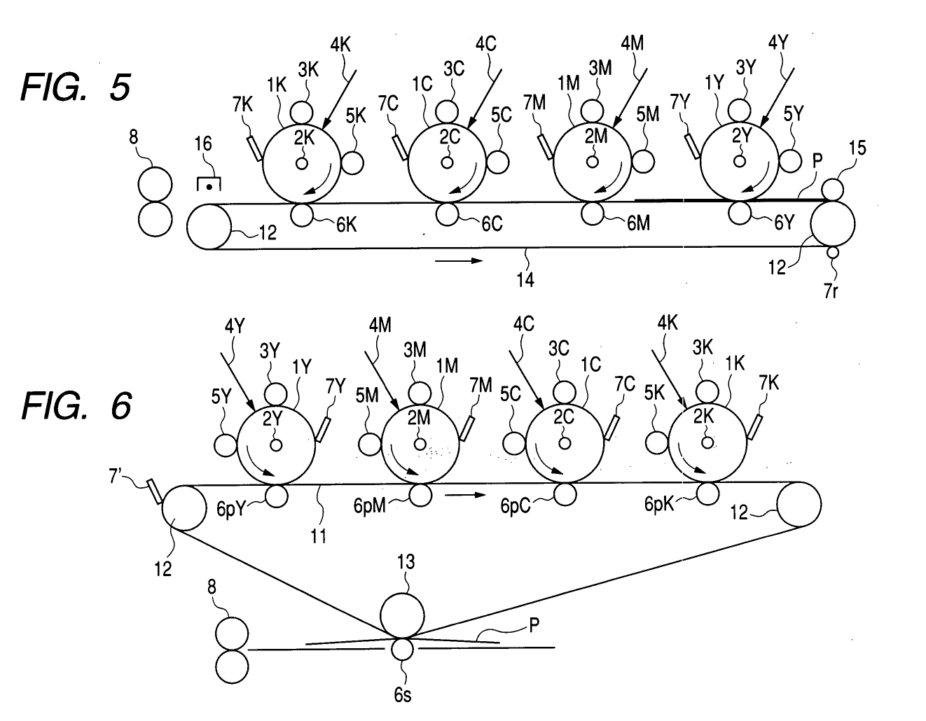

FIG. 5 schematically illustrates an example of the construction of a color electrophotographic apparatus of an in-line system. The transfer of toner images from an electrophotographic photosensitive member to a transfer material is chiefly performed by a transfer material transport member and a transfer charging member.

In FIG. 5, reference numerals 1Y, 1M, 1C and 1K denote cylindrical electrophotographic photosensitive members (electrophotographic photosensitive members for first color to fourth color), which are rotatingly driven around axes 2Y, 2M, 2C and 2K, respectively, in the directions of arrows at a stated peripheral speed each.

The surface of the electrophotographic photosensitive member 1Y for first color which is rotatingly driven is uniformly electrostatically charged to a positive or negative, given potential through a primary charging member for first color. The electrophotographic photosensitive member thus charged is then exposed to exposure light (imagewise exposure light) 4Y emitted from an exposure means (not shown) for slit exposure, laser beam scanning exposure or the like. The exposure light 4Y is exposure light corresponding to a first-color component image (e.g., a yellow component image) of an intended color image. In this way, first-color component electrostatic latent images (yellow component electrostatic latent images) corresponding to the first-color component image of the intended color image are successively formed on the surface of the electrophotographic photosensitive member 1Y.

A transfer material transport belt 14 stretched by stretch-over rollers 12 are rotatingly driven in the direction of an arrow at substantially the same peripheral speed as the electrophotographic photosensitive members 1Y, 1M, 1C and 1K for first color to fourth color (e.g., 97% to 103% in respect to the peripheral speed of each of the electrophotographic photosensitive members 1Y, 1M, 1C and 1K for first color to fourth color). Also, a transfer material (such as paper) P fed from a transfer material feed means (not shown) is electrostatically held on (attracted to) the transfer material transport belt 14, and is successively transported to the parts (contact zones) between the electrophotographic photosensitive members 1Y, 1M, 1C and 1K for first color to fourth color and the transfer material transport belt.

The first-color component electrostatic latent images thus formed on the surface of the electrophotographic photosensitive member 1Y for first color are developed with a first-color toner contained in a developer held on a developer carrying member 5Y for first color to form first-color toner images (yellow toner images). Then, the first-color toner images thus formed and held on the surface of the electrophotographic photosensitive member 1Y for first color are successively transferred by the aid of a transfer bias applied from a transfer charging member 6Y for first color (transfer charging roller for first color), which are transferred on to a transfer material P held on the transfer material transport belt 14 which passes through between the electrophotographic photosensitive member 1Y for first color and the transfer member 6Y for first color.

The surface of the electrophotographic photosensitive member 1Y for first color from which the first-color toner images have been transferred is brought to removal of the transfer residual developer (toner) through a cleaning member 7Y for first color (cleaning blade for first color). Thus, the surface is cleaned, and thereafter the electrophotographic photosensitive member 1Y for first color is repeatedly used for the formation of the first-color toner images.

The electrophotographic photosensitive member 1Y for first color, the primary charging member 3Y for first color, the exposure means for first color, the developer carrying member 5Y for first color and the transfer charging member 6Y for first color are collectively called an image forming section for first color.

An image forming section for second color which has an electrophotographic photosensitive member 1M for second color, a primary charging member 3M for second color, an exposure means for second color, a developer carrying member 5M for second color and a transfer charging member 6M for second color, an image forming section for third color which has an electrophotographic photosensitive member 1C for third color, a primary charging member 3C for third color, an exposure means for third color, a developer carrying member 5C for third color and a transfer charging member 6C for third color, and an image forming section for fourth color which has an electrophotographic photosensitive member 1K for fourth color, a primary charging member 3K for fourth color, an exposure means for fourth color, a developer carrying member 5K for fourth color and a transfer charging member 6K for fourth color are operated in the same way as the operation of the image forming section for first color. Thus, second-color toner images (magenta toner images), third-color toner images (cyan toner images) and fourth-color toner images (black toner images) are transferred on in order, to the transfer material P which is held on the transfer material transport belt 14 and to which the first-color toner images have been transferred. In this way, synthesized toner images corresponding to the intended color image are formed on the transfer material P held on the transfer material transport belt 14.

The transfer material P on which the synthesized toner images have been formed is separated from the surface of the transfer material transport belt 14, is guided into a fixing means 8, where the toner images are fixed, and is then put out of the apparatus as a color-image-formed material (a print or a copy).

The surfaces of the electrophotographic photosensitive members 1Y, 1M, 1C and 1K for first color to fourth color from which the transfer residual developers (toners) have been removed by the cleaning members 7Y, 7M, 7C and 7K, respectively, may also be subjected to charge elimination by pre-exposure light emitted from pre-exposure means. However, where as shown in FIG. 5 contact charging making use of a roller-shaped primary charging member (a primary charging roller) or the like is employed in the charging of the surface of each electrophotographic photosensitive member, the pre-exposure is not necessarily required.

Incidentally, in FIG. 5, reference numeral 15 denotes an attraction roller for attracting the transfer material to the transfer material transport belt; and 16, a separation charging assembly for separating the transfer material from the transfer material transport belt.

FIG. 6 schematically illustrates another example of the construction of a color electrophotographic apparatus of an intermediate transfer system. In the case of the intermediate transfer system, the transfer of toner images from an electrophotographic photosensitive member to a transfer material is chiefly performed by a primary transfer charging member, an intermediate transfer belt and a secondary transfer charging member.

In FIG. 6, reference numerals 1Y, 1M, 1C and 1K denote cylindrical electrophotographic photosensitive members (electrophotographic photosensitive members for first color to fourth color), which are rotatingly driven around axes 2Y, 2M, 2C and 2K, respectively, in the directions of arrows at a stated peripheral speed each.

The surface of the electrophotographic photosensitive member 1Y for first color which is rotatingly driven is uniformly electrostatically charged to a positive or negative, given potential through a primary charging member 3r for first color. The electrophotographic photosensitive member thus charged is then exposed to exposure light (imagewise exposure light) 4Y emitted from an exposure means (not shown) for slit exposure, laser beam scanning exposure or the like. The exposure light 4Y is exposure light corresponding to a first-color component image (e.g., a yellow component image) of an intended color image. In this way, first-color component electrostatic latent images (yellow component electrostatic latent images) corresponding to the first-color component image of the intended color image are successively formed on the surface of the electrophotographic photosensitive member 1Y.

An intermediate transfer belt 11 stretched over stretch-over rollers 12 and a secondary-transfer opposing roller 13 are rotatingly driven in the direction of an arrow at substantially the same peripheral speed as the electrophotographic photosensitive members 1Y, 1M, 1C and 1K for first color to fourth color (e.g., 97% to 103% in respect to the peripheral speed of each of the electrophotographic photosensitive members 1Y, 1M, 1C and 1K for first color to fourth color).

The first-color component electrostatic latent images thus formed on the surface of the electrophotographic photosensitive member 1Y for first color are developed with a first-color toner contained in a developer held on a developer carrying member 5Y for first color to form first-color toner images (yellow toner images). Then, the first-color toner images thus formed and held on the surface of the electrophotographic photosensitive member 1Y for first color are successively primarily transferred by the aid of a primary transfer bias applied from a primary transfer charging member 6pY for first color (primary transfer charging roller for first color), which are transferred on to the surface of an intermediate transfer belt 11 which passes the part between the electrophotographic photosensitive member 1Y for first color and the primary transfer member 6pY for first color.

The surface of the electrophotographic photosensitive member 1Y for first color from which the first-color toner images have been transferred is brought to removal of the transfer residual developer (toner) through a cleaning member 7Y for first color (cleaning blade for first color). Thus, the surface is cleaned, and thereafter the electrophotographic photosensitive member 1Y for first color is repeatedly used for the formation of the first-color toner images.

The electrophotographic photosensitive member 1Y for first color, the primary charging member 3Y for first color, the exposure means for first color, the developer carrying member 5Y for first color and the transfer charging member 6pY for first color are collectively called an image forming section for first color.

An image forming section for second color which has an electrophotographic photosensitive member 1M for second color, a primary charging member 3M for second color, an exposure means for second color, a developer carrying member 5M for second color and a primary transfer charging member 6pM for second color, an image forming section for third color which has an electrophotographic photosensitive member 1C for third color, a primary charging member 3C for third color, an exposure means for third color, a developer carrying member 5C for third color and a primary transfer charging member 6pC for third color, and an image forming section for fourth color which has an electrophotographic photosensitive member 1K for fourth color, a primary charging member 3K for fourth color, an exposure means for fourth color, a developer carrying member 5K for fourth color and a primary transfer charging member 6pK for fourth color are operated in the same way as the operation of the image forming section for first color. Thus, second-color toner images (magenta toner images), third-color toner images (cyan toner images) and fourth-color toner images (black toner images) are transferred on in order, to the surface of the intermediate transfer belt 11. In this way, synthesized toner images corresponding to the intended color image are formed on the surface of the intermediate transfer belt 11.

The synthesized toner images formed on the surface of the intermediate transfer belt 11 are successively secondarily transferred on to a transfer material (such as paper) P by the aid of a secondary-transfer bias applied from a secondary-transfer charging member 6s; the transfer material P being taken out and fed from a transfer material feeding means (not shown) to the part (contact zone) between the secondary-transfer opposing roller 13/intermediate transfer belt 11 and the secondary-transfer charging member 6s in the manner synchronized with the rotation of the intermediate transfer belt 11.

The transfer material P to which the synthesized toner images have been transferred is separated from the surface of the intermediate transfer belt 11, is guided into a fixing means 8, where the toner images are fixed, and is then put out of the apparatus as a color-image-formed material (a print or a copy).

The surface of the intermediate transfer belt 11 from which the synthesized toner images have been transferred is brought to removal of secondary-transfer residual developers (toners) through an intermediate transfer belt cleaning member 7′. Thus, its surface is cleaned, and thereafter it is repeatedly used for the formation of the synthesized toner images.

The surfaces of the electrophotographic photosensitive members 1Y, 1M, 1C and 1K for first color to fourth color from which the transfer residual developers (toners) have been removed by the cleaning members 7Y, 7M, 7C and 7K for the first color to fourth color, respectively, may also be subjected to charge elimination by pre-exposure light emitted from pre-exposure means. However, where as shown in FIG. 6 contact charging making use of a roller-shaped primary charging member (a primary charging roller) or the like is employed in the charging of the surface of each electrophotographic photosensitive member, the pre-exposure is not necessarily required.

The electrophotographic endless belt of the present invention may preferably be used in the above intermediate transfer belt and transfer material transporting belt.

In the foregoing, in regard to the electrophotographic endless belt of the present invention, it has chiefly been described on a case in which it is used as the intermediate transfer belt or the transfer material transporting belt. However, besides the intermediate transfer belt or the transfer material transporting belt, the electrophotographic endless belt of the present invention is applicable to the whole field of endless belts used in electrophotographic apparatus, such as a photosensitive belt, a transfer belt, transporting belts other than the transfer material transporting belt, a fixing belt, a developing belt, a charging belt and a paper feed belt.

The electrophotographic endless belt of the present invention may also be set in the main body of the electrophotographic apparatus as it is, or may be used as an endless belt cartridge in the form that it is detachably mountable to the main body of the electrophotographic apparatus. For example, a process cartridge may be set up in which the electrophotographic endless belt of the present invention and electrophotographic process members such as the electrophotographic photosensitive member and the primary charging member are set integral.

The present invention is described below in greater details by giving specific working examples. Note that the present invention is by no means limited to these. In the following Examples, “part(s)” refers to “part(s) by weight”.

Evaluation of flexing resistance, evaluation of creep resistance and evaluation on resistance change due to environment were made in the following way.

Evaluation of Flexing Resistance:

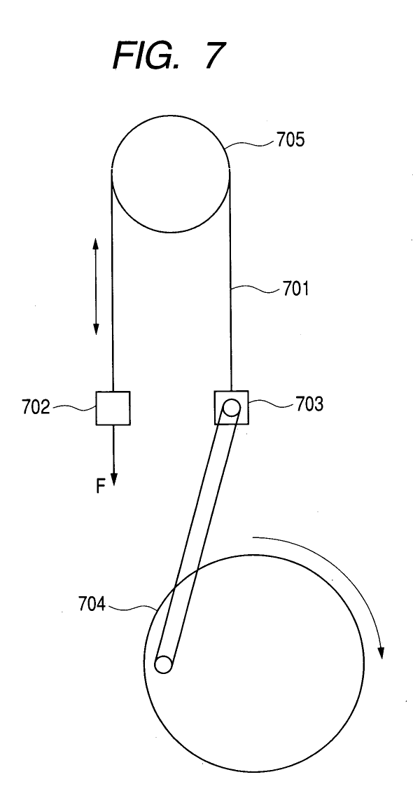

The flexing resistance is evaluated using a flexing tester set up as shown in FIG. 7.

Where the electrophotographic endless belt has a thickness of 100 μm, the electrophotographic endless belt is cut in a strip of 20 mm in width and 200 mm in length. This strip-shaped sample 701 is set on chucks 702 and 703 of the flexing tester. The chuck 703 is connected to the crank 704 side, and a load (F) of 1 kg is applied to the chuck 702. Driving the crank 704 (rotating a disk in the direction of an arrow) makes the strip-shaped sample 701 move reciprocally over a roller (free rotatable) 705 to make it bend and stretch repeatedly.

Through this test, a stress more than that which the electrophotographic endless belt receives actually in the electrophotographic apparatus can be applied to the sample.

The roller 705 is 10 mm in diameter, 20 mm in movement stroke, and movable at a speed of 0.5 second per one reciprocation.

Incidentally, the load per unit sectional area of the strip-shaped sample 701 must be uniform in every sample, and hence, where, e.g., the electrophotographic endless belt has a thickness of 200 μm, the strip-shaped sample is prepared in a width of 10 mm.

In conducting this test, a sample which did neither break nor crack even after 1,000,000-time reciprocation is judged to have flexing resistance.

Evaluation of Creep Resistance:

In evaluating the above flexing resistance, the distance (L0) between the two chucks before evaluation is measured, and the distance (L1) between the two chucks after 1,000,000-time reciprocation is measured. Evaluated as:
Creep rate (%)=(L1−L0)/L0×100.

In conducting this test, a sample having the value of a creep rate of less than 4% is judged to have creep resistance.

Resistance Change Due to Environment:

Evaluated by the logarithm of a difference (environmental resistance difference) between volume resistivity (RvL) measured in an environment of 15° C./10% RH (L/L) and volume resistivity (RvH) measured in an environment of 30° C./80% RH(H/H). A sample having this value in less than two figures is judged to cause less resistance change due to environment.

### EXAMPLE 1

An electrophotographic endless belt was produced using the following materials.

| | | |
|---|---|---|
| Polyamide 610 | 40 | parts |
| Polyamide 12 | 30 | parts |
| Carbon black (DENKA BLACK powdery product) | 12 | parts |
| Zinc oxide | 13.76 | parts |
| Modified polyolefin | 4 | parts |
| Dispersing agent | 0.12 | part |
| Antioxidant | 0.12 | part |

The polyamide 610, the polyamide 12, the modified polyolefin and the antioxidant were mixed by means of a tumbling mixer. Also, separately, the carbon black and the dispersing agent were mixed by means of Henschel mixer.

Next, in the apparatus set up as shown in FIG. 3, the polyamide 610, polyamide 12, modified polyolefin and antioxidant having been mixed beforehand were introduced into the twin-screw extruder 301 from the hopper 302. At the stage the resin melted, the zinc oxide and the carbon black and dispersing agent having been mixed beforehand were introduced into the twin-screw extruder 301 from the hopper 302′.

The above materials having been melt-kneaded (kneading temperature: 260° C.) by means of the twin-screw extruder 301 were extruded from the strand die 303 in the form of the strand 304, which was then passed through the water bath 305 so as to be cooled, and then passed through the strand cutter 306 to obtain an extrusion material.

Next, in the apparatus set up as shown in FIG. 1, the extrusion material was introduced into the hopper 102 installed to the extruder 101, and the blown-film extrusion (inflation molding) described previously was carried out to obtain an endless belt.

Next, using a set of cylindrical forms made of materials having different coefficients of thermal expansion and having different diameters, folds of the endless belt obtained were removed, surface smoothness thereof was adjusted and size thereof was adjusted all in the manner as described previously. Here, the heating of the form in which the inner form, the endless belt and the outer form were set in the order from the inside was carried out at 200° C. for 20 minutes.

Next, both edges of the endless belt whose folds were removed, surface smoothness was adjusted and size was adjusted were precisely cut to obtain an electrophotographic endless belt of 480 mm in peripheral length, 250 mm in width and 100 μm in thickness. A meandering preventive member was also attached to the back of this electrophotographic endless belt.

The flexing resistance and creep resistance of the electrophotographic endless belt obtained were evaluated. As a result of the evaluation, the belt was seen to have good flexing resistance and creep resistance.

The electrophotographic endless belt obtained was also set as a transfer material transporting belt in the electrophotographic apparatus (color laser printer) set up as shown in FIG. 5, reproduction of full-color images was tested in each environment of N/N, L/L and H/H to evaluate images at the initial stage. As a result of the evaluation, good images were seen to be obtainable which were free of any faulty images such as color aberration, in particular, free of spots around line images or hollow characters, which is due to the addition of the modified polyolefin.

Thereafter, in each environment, a running test of image reproduction on 10,000 sheets was conducted. After the running test was finished, the electrophotographic endless belt (transfer material transporting belt) was observed. As a result, any trouble such as cracking, breaking or tearing was not seen, and moreover any creep was not seen that might adversely affect the operation of the electrophotographic apparatus or the quality of reproduced images.

The results of evaluation are shown in Table 1.

### EXAMPLES 2 TO 5

Electrophotographic endless belts (transfer material transporting belts) were produced in the same manner as in Example 1 except that the materials used therein were changed as shown in Table 1. Evaluation was made in the same way. The results of evaluation are shown in Table 1.

### EXAMPLE 6

An electrophotographic endless belt was produced in the same manner as in Example 1 except that the materials used therein were changed as shown in Table 1 and that the electrophotographic endless belt was formed in a size of 440 mm in peripheral length, 240 mm in width and 100 μm in thickness.

The electrophotographic endless belt obtained was set as a transfer material transporting belt in the electrophotographic apparatus (color laser printer) set up as shown in FIG. 5, and evaluation was made on the same evaluation items as those in Example 1. The results of evaluation are shown in Table 1.

### EXAMPLES 7

An electrophotographic endless belt was produced in the same manner as in Example 1 except that the materials used therein were changed as shown in Table 1 and that the electrophotographic endless belt was formed in a size of 700 mm in peripheral length, 260 mm in width and 100 μm in thickness.

The electrophotographic endless belt obtained was set as an intermediate transfer belt in the electrophotographic apparatus (color laser printer) set up as shown in FIG. 6, and evaluation was made on the same evaluation items as those in Example 1. The results of evaluation are shown in Table 1.

### COMPARATIVE EXAMPLES 1 TO 9

Electrophotographic endless belts (transfer material transporting belts) were produced in the same manner as in Example 1 except that the materials used therein were changed as shown in Table 1 and that the kneading temperature was set to 270° C. in Comparative Example 1, 300° C. in Comparative Example 2, 330° C. in Comparative Example 3, and 280° C. in Comparative Example 4. Evaluation was made in the same way. In Comparative Example 8, the electrophotographic endless belt broke in the flexing test, and hence the creep resistance was not able to be evaluated. The results of evaluation are shown in Table 2.

TABLE 1

| Materials | Example | | | | | | |
|---|---|---|---|---|---|---|---|
| [part(s)] | 1 | 2 | 3 | 4 | 5 | 6 | 7 |
| Polyamide resin: | | | | | | | |
| PA610 | 40 | — | 37 | 67 | — | — | — |
| PA612 | — | — | — | — | — | 60 | — |
| PA11 | — | — | — | — | — | — | 67 |
| PA12 | 30 | 74 | 37 | — | 67 | — | — |
| PA6 | — | — | — | — | — | — | — |
| PA66 | — | — | — | — | — | — | — |
| PA46 | — | — | — | — | — | — | — |
| MXD6 | — | — | — | — | — | — | — |
| Carbon black: | | | | | | | |
| DENKA | 12 | 13 | 12 | 12 | 13 | — | — |
| EC600JD | — | — | — | — | — | — | 3.3 |
| REGAL 400 | — | — | — | — | — | 35 | — |
| Filler: | | | | | | | |
| ZnO | 13.76 | 13 | 13.88 | 13.88 | 12.37 | — | — |
| Mg(OH)₂ | — | — | — | — | — | — | 20.7 |
| CaCO₃ | — | — | — | — | — | 5 | — |
| BaSO₄ | — | — | — | — | — | — | — |
| Modified polyolefin: | | | | | | | |
| E-GMA | 4 | — | — | — | 7 | — | — |
| MAH-PE | — | — | — | 7 | — | — | — |
| Dispersing agent: | | | | | | | |
| H-818 | 0.12 | — | 0.12 | — | 0.13 | — | — |
| P-4 | — | — | — | 0.12 | — | — | — |
| Antioxidant: | | | | | | | |
| CuI | 0.12 | — | — | — | — | — | — |
| IRGANOX | — | — | — | — | 0.5 | — | — |
| Flame retardant: | | | | | | | |
| MCN | — | — | — | — | — | — | 9 |
| Antistatic agent: | | | | | | | |
| PEEA | — | — | — | — | — | — | — |
| Total: | 100 | 100 | 100 | 100 | 100 | 100 | 100 |
| Volume resistivity: | 2 × 10¹¹ | 1 × 10¹² | 3 × 10¹⁰ | 3 × 10⁹ | 2 × 10¹² | 3 × 10¹⁰ | 8 × 10⁹ |
| (Ω · cm) | | | | | | | |
| Type of belt: | ETB | ETB | ETB | ETB | ETB | ITB | ITB |
| Results of evaluation | | | | | | | |
| Flexing resistance: | A | A | A | A | A | A | A |
| Creep resistance: | AA | A | AA | AA | A | AA | AA |
| Environmental resistance difference: | A | A | A | A | A | A | A |
| Initial-stage images: | A | A | A | A | A | A | A |
| After running test: | A | A | A | A | A | A | A |

TABLE 2

| Materials | Comparative Example | | | | | | | | |
|---|---|---|---|---|---|---|---|---|---|
| [part(s)] | 1 | 2 | 3 | 4 | 5 | 6 | 7 | 8 | 9 |
| Polyamide resin: | | | | | | | | | |
| PA610 | — | — | — | — | — | — | — | — | — |
| PA612 | — | — | — | — | — | — | — | — | — |
| PA11 | — | — | — | — | — | — | — | — | — |
| PA12 | — | — | — | — | 87 | 74 | 92 | 45 | 80 |
| PA6 | 74 | — | — | — | — | — | — | — | — |
| PA66 | — | 74 | — | — | — | — | — | — | — |
| PA46 | — | — | 74 | — | — | — | — | — | — |
| MXD6 | — | — | — | 74 | — | — | — | — | — |
| Carbon black: | | | | | | | | | |
| DENKA | 13 | 13 | 13 | 13 | 13 | 13 | — | — | — |
| EC600JD | — | — | — | — | — | — | 3 | — | — |
| REGAL400 | — | — | — | — | — | — | — | 30 | — |
| Filler: | | | | | | | | | |
| ZnO | 13 | 13 | 13 | 13 | — | — | 5 | 25 | 10 |
| Mg(OH)₂ | — | — | — | — | — | — | — | — | — |
| CaCO₃ | — | — | — | — | — | — | — | — | — |
| BaSO₄ | — | — | — | — | — | 13 | — | — | — |
| Modified polyolefin: | | | | | | | | | |
| E-GMA | — | — | — | — | — | — | — | — | — |
| MAH-PE | — | — | — | — | — | — | — | — | — |
| Dispersing agent: | | | | | | | | | |
| H-818 | — | — | — | — | — | — | — | — | — |
| P-4 | — | — | — | — | — | — | — | — | — |
| Antioxidant: | | | | | | | | | |
| CuI | — | — | — | — | — | — | — | — | — |
| IRGANOX | — | — | — | — | — | — | — | — | — |
| Flame retardant: | | | | | | | | | |
| MCN | — | — | — | — | — | — | — | — | — |
| Antistatic agent: | | | | | | | | | |
| PEEA | — | — | — | — | — | — | — | — | 10 |
| Total: | 100 | 100 | 100 | 100 | 100 | 100 | 100 | 100 | 100 |
| Volume resistivity: | 3 × 10¹¹ | 1 × 10¹¹ | 2 × 10¹² | 8 × 10¹¹ | 1 × 10¹² | 1 × 10¹² | 1 × 10¹⁰ | 2 × 10¹¹ | 2 × 10¹² |
| (Ω · cm) | | | | | | | | | |
| Type of belt: | ETB | ETB | ETB | ETB | ETB | ETB | ETB | ETB | ETB |
| Results of evaluation | | | | | | | | | |
| Flexing resistance: | A | A | A | A | A | A | A | C | A |
| Creep resistance: | AA | AA | AA | AA | C | C | B | — | C |
| Environmental resistance | C | C | C | C | A | A | B | A | C |
| difference: | | | | | | | | | |
| Initial-stage images: | C | C | C | C | B | A | B | A | C |
| After running test: | A | A | A | A | C | C | C | C | C |

Explanation of Tables 1 and 2 is given below.

Polyamide Resin:
“PA”: “Polyamide”
PA610: AMILAN CM2001, available from Toray Industries, Inc.
PA612: DIAMID D22, available from Daicel-Degussa Ltd.
PA11: RILSAN BESN O TL, available from Atofina Co.
PA12: UBESTA 3030U, available from Ube Industries, Ltd.
PA6: AMILAN CM1041 (LO), available from Toray Industries, Inc.
PA66: LEONA 1700S, available from Asahi Chemical Industry Co., Ltd.
PA46: STANYL TS300, available from DJEP.
MXD6: MX Nylon S6121, available from Mitsubishi Gas Chemical Company, Inc.

Carbon Black:
DENKA: DENKA BLACK, powdery product, available from Denki Kagaku Kogyo Kabushiki Kaisha.
EC600JD: KETJEN BLACK EC600JD, available from Lion Corporation.
REGAL 400: Available from Cabot Corp.

Modified Polyolefin:
E-GMA: Ethylene/glycidyl methacrylate copolymer, BOND FAST, available from Sumitomo Chemical Co., Ltd.
MAH-PE: Maleic acid modified polyethylene, NUC Polyethylene GA-004, available from Nippon Unicar Co., Ltd.

Dispersing Agent:
H-818: Polyglycerol poly-ricinolate, CHIRABAZOL H818, available from Taiyo Kagaku Co., Ltd.
P-4: Polyglycerol stearate, CHIRABAZOL P-4, available from Taiyo Kagaku Co., Ltd.

Antioxidant:
IRGANOX: IRGANOX 245, available from Ciba Specialty Chemicals Inc.

Flame Retardant:
MCN: Melamine cyanurate, available from Nissan Chemical Industries, Ltd.

Antistatic Agent:
PEEA: Polyether ester amide resin, PELESTAT NC6321, available from Sanyo Chemical Industries, Ltd.

Type of Belt:
ETB: Transfer material transporting belt.
ITB: Intermediate transfer belt.

Volume Resistivity:

Measured as described previously (in N/N environment; 100 V applied).

Flexing Resistance:

In the flexing resistance evaluation test, a sample which did neither break nor crack even as a result of 1,000,000-time reciprocation was evaluated as “A”, and a sample which broke or cracked before finish of 1,000,000-time reciprocation was evaluated as “C”.

Creep Resistance:

In the creep resistance evaluation test, a sample having a creep rate of less than 1% was evaluated as “AA”; 1% or more to less than 3%, “A”; 3% or more to less than 4%, “B”; and 4% or more, “C”.

Environmental Resistance Difference:

A sample of less than one figure was evaluated as “A”; one figure or more to less than two figures, “B”; and two figures or more, “C”.

Initial-Stage Images:

A case in which good images were formed in all the environments of N/N, L/L and H/H was evaluated as “A”; good images were formed in the environment of N/N but some faulty images were seen in the environment of L/L or H/H, “B”; and some faulty images were seen in the environments of L/L and H/H, “C”.

After Running Test:

A sample showing good results in all the environments of N/N, L/L and H/H was evaluated as “A”; and a sample having caused creep, breaking or cracking in any of the environments of N/N, L/L and H/H, “C”.

This application claims priority from Japanese Patent Application Nos. 2003-399887 filed Nov. 28, 2003, and 2003-422931 filed Dec. 19, 2003, both of which are hereby incorporated by reference herein.

1. An electrophotographic endless belt comprising a polyamide resin, carbon black and a filler;
said polyamide resin being at least one resin selected from the group consisting of polyamide 610, polyamide 612, polyamide 11 and polyamide 12;
said filler being at least one filler selected from the group consisting of an oxide, a hydroxide, a carbonate and a silicate; and
weight (A) of said polyamide resin and total weight (B) of said carbon black and said filler being in a ratio (A:B) of from 90:10 to 50:50.

2. The electrophotographic endless belt according to claim 1, wherein the weight (A) of said polyamide resin and the total weight (B) of said carbon black and said filler is in a ratio (A:B) of from 75:25 to 60:40.

3. The electrophotographic endless belt according to claim 1, wherein said polyamide resin is a mixture of two types of resins selected from the group consisting of polyamide 610, polyamide 612, polyamide 11 and polyamide 12, and the two types of resins are in a weight ratio of from 10:90 to 90:10.

4. The electrophotographic endless belt according to claim 1, which further comprises at least one of a modified polyolefin and a thermoplastic elastomer.

5. The electrophotographic endless belt according to claim 4, wherein said modified polyolefin is maleic acid modified polyolefin or a copolymer of glycidyl methacrylate and polyethylene.

6. The electrophotographic endless belt according to claim 1, which further comprises an antioxidant.

7. The electrophotographic endless belt according to claim 1, which further comprises a flame retardant.

8. The electrophotographic endless belt according to claim 1, which further comprises a dispersing agent.

9. The electrophotographic endless belt according to claim 8, wherein said dispersing agent is polyglycerol poly-ricinolate, or polyglycerol stearate.

10. The electrophotographic endless belt according to claim 1, which is a transfer material transporting belt.

11. The electrophotographic endless belt according to claim 1, which is an intermediate transfer belt.

12. An electrophotographic apparatus comprising an electrophotographic endless belt comprising a polyamide resin, carbon black and a filler, wherein;
said polyamide resin is at least one resin selected from the group consisting of polyamide 610, polyamide 612, polyamide 11 and polyamide 12;
said filler is at least one filler selected from the group consisting of an oxide, a hydroxide, a carbonate and a silicate; and
weight (A) of said polyamide resin and total weight (B) of said carbon black and said filler is in a ratio (A:B) of from 90:10 to 50:50.

13. A process for producing an electrophotographic endless belt comprising a polyamide resin, carbon black and a filler; the polyamide resin being at least one resin selected from the group consisting of polyamide 610, polyamide 612, polyamide 11 and polyamide 12; the filler being at least one filler selected from the group consisting of an oxide, a hydroxide, a carbonate and a silicate; and weight (A) of the polyamide resin and total weight (B) of the carbon black and the filler being in a ratio (A:B) of from 90:10 to 50:50; the process comprising:
a resin introduction step of introducing said polyamide resin into a twin-screw extruder; and
a carbon black and filler introduction step of introducing said carbon black and said filler into the twin-screw extruder at the time the polyamide resin having been introduced into the twin-screw extruder through the resin introduction step has melted.
